(19) United States
(12) Patent Application Publication
(10) Pub. No.: US 2006/0019532 A1
(43) Pub. Date: Jan. 26, 2006

(54) Universal USB cable

(76) Inventor: Laszlo Kiss JR., Tucson, AZ (US)

Correspondence Address: Laszlo Kiss Jr., 52 N. Euclid Ave., Tucson, AZ, 85719, US

(21) Appl. No.: 11/149,099

(22) Filed: Jun. 10, 2005

Related U.S. Application Data
(60) Provisional application No. 60/590,983, filed on Jul. 26, 2004.

(51) Int. Cl. H01R 11/00

(52) U.S. Cl. 439/505

(57) ABSTRACT

A USB type A male connector at one end of a length of a 4 wire shielded cable, that connects to the USB port (on all computers which include USB ports) On the other end a USB type A female connector is serially connected to a USB type A male connector, that is serially connected to a USB type B male connector, and that is serially connected to a USB type Mini A male connector ending the assembly. The organization of the serially connected USB connectors can be mixed in any way like starting with a B male connector connecting to an A female connecting to an A male connector or any mixture of above.

### REFERENCES CITED

### U.S. Patent Documents

| | | | |
|---|---|---|---|
| 6475033 | November 2002 | Zhu et al. | 439/607 |
| 5961350 | October 1999 | Shiu | 439/607 |
| 6733328 | May 2004 | Lin et al. | 439/501 |
| 6722917 | April 2004 | Huang | 439/501 |
| 6210216 | April 2001 | Tso-Chin et al. | 439/545 |

### Other References

USB cable technical specifications
How USB Ports work: http://www.howstuffworks.com/usb/htm

### Parent Case Text

Priority

This application incorporates by reference and claim priority, as a continuation in part, from provisional application Ser. No. 60/590,983, filed on Jul. 26, 2004, entitled Universal USB Cable.

The present invention relates to simplifying and combining the current USB cable systems. The current USB cable systems are uniquely built to connect to a computer and to a device that is using that one connection type that is built in to the end of the USB cable. No other device can be connected to the cable that uses a different type USB connector.

This Universal USB Cable system will connect up to four different USB connector type devices, on the same cable assembly, but one device at a time. If the user connects two devices on the cable assembly at the same time the two device will cancel each other out and will mix the USB signal making the assembly unusable.

The Universal USB Cable is most useful in case of needing to use devices with different connectors, or in case of having to carry many USB cables. Now the user only needs to carry one cable that can supply many devices.

### DESCRIPTION OF THE DRAWING

FIG. 1 shows an open view of how the wires are connected to each USB connectors. The shielded wires are connected as: red wire to red wire, white wire to white wire, green wire to green wire, and black wire to black wire. The wires are colored so no mixing of connections would occur. The way the first connector is wired that is how all the following connectors must be wired also.

FIG. 2 A is showing a USB type A Male connector that will connect to the USB port in a computer. FIG. 2 B, The next connector in the cable assembly is a USB type A Female, that is connected to the next connector witch is FIG. 2 C is a USB type A Male. The next connector in the chain of the cable assembly is FIG. 2 D is a USB type B Male witch connects to the last connector that is FIG. 2 E that represents a USB type Mini A Male ending the cable.

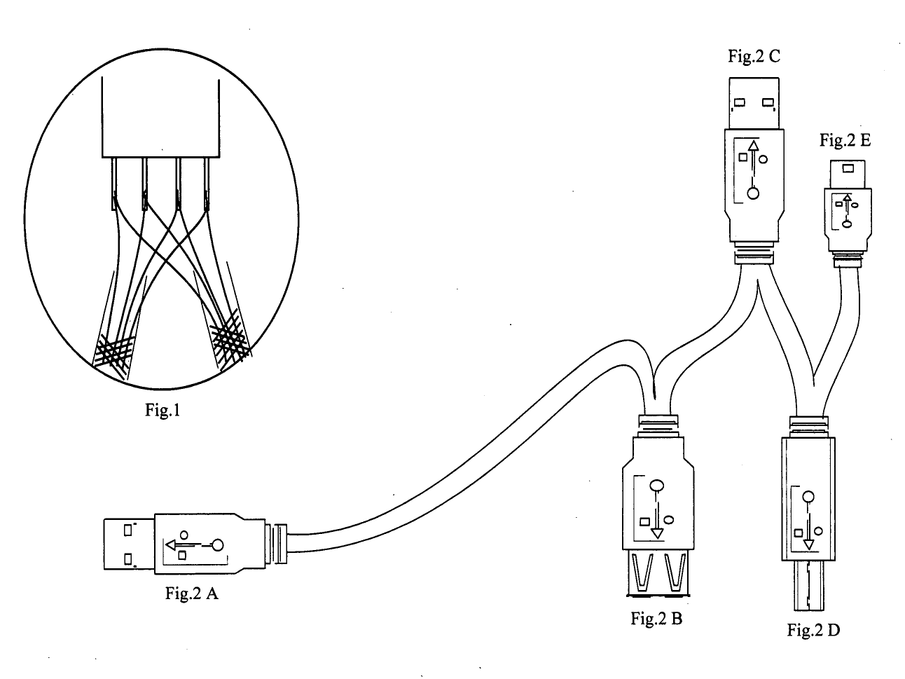

What is claimed is:

1. A combination of USB connectors serially connected to each other can be used to connect one USB device to a computer, even if the devices use different types of USB connections.

2. A combination of USB connectors can be connected to each other to make up a cable assembly in any serial order and still be used to connect external USB devices that use different connection types.

3. One device can be connected to the cable assembly at a time, so no signal mixing occurs.

4. Example: A printer that has a USB-B connector, a camera that has a Mini connector, and a USB network adapter that has a USB-A type connector can use the same Universal USB Cable assembly. No need for three different cables.
